(19) United States
(12) Patent Application Publication
(10) Pub. No.: US 2025/0238612 A1
(43) Pub. Date: Jul. 24, 2025

(54) Systems and Methods for Domain-Agnostic Context Extraction in Natural Language Processing

(71) Applicant: Samsung Electronics Company, Ltd., SUWON SI (KR)

(72) Inventors: Paul S. Hope, Langley (CA); Jeremy W.K. Lee, Vancouver (CA)

(21) Appl. No.: 18/421,283

(22) Filed: Jan. 24, 2024

(51) Int. Cl. G06F 40/279; G06F 40/166; G06F 40/30

(52) U.S. Cl. CPC G06F 40/279; G06F 40/166; G06F 40/30

(57) ABSTRACT

In one embodiment, a method includes determining speech tags for multiple words associated with a body of text by a language model, processing the words by determining whether each word is a noun, proper noun, or adposition by a domain-agnostic context extraction (DCE) model to generate a set of n-grams corresponding to a domain-agnostic context of the body of text, and generating a contextual summary of the body of text based on the set of n-grams.

### TECHNICAL FIELD

This disclosure relates generally to natural language processing, and in particular relates to systems and methods for context extraction in natural language processing.

### BACKGROUND

Natural language processing (NLP) is an interdisciplinary subfield of computer science and linguistics. It is primarily concerned with giving computers the ability to support and manipulate human language. It involves processing natural language datasets, such as text corpora or speech corpora, using either rule-based or probabilistic (i.e., statistical and, most recently, neural network-based) machine learning approaches. The goal is a computer capable of “understanding” the contents of documents, including the contextual nuances of the language within them. The technology can then accurately extract information and insights contained in the documents as well as categorize and organize the documents themselves.

### BRIEF DESCRIPTION OF THE DRAWINGS

FIG. 1 illustrates an example flow diagram for extracting domain-agnostic context.

FIGS. 2A-2B illustrate an example diagram for deriving entities from a body of text using domain-agnostic context extraction.

FIG. 3 illustrates is a flow diagram of a method for extracting domain-agnostic context, in accordance with the presently disclosed embodiments.

FIG. 4 illustrates an example computer system that may be utilized to extract domain-agnostic context, in accordance with the presently disclosed embodiments.

### DESCRIPTION OF EXAMPLE EMBODIMENTS

### Domain-Agnostic Context Extraction in Natural Language Processing

In particular embodiments, a computing system may extract domain-agnostic context from larger groups of words by applying a word logic to the larger groups of words to discover new groups of words, acronyms, or abbreviations. The word logic may create a group of words and the word logic may be used in any way to identify abbreviations and acronyms based on the position of words next to each other in a group of words. Inside that group of words, an abbreviation or acronym logic may be performed to create both the new group of words and abbreviations and acronyms. As an example and not by way of limitation, domain-agnostic context extraction may help find contextual domain-agnostic summary, tags, categories, labels, abbreviations, and acronyms, based on any group of words that were previously unknown. Domain-agnostic context extraction may search specific domains to generate more meaningful context of the text, identify abbreviations or acronyms based on the meaningful context, and summarize the text through the meaningful context. The following is an example of domain-agnostic context extraction using the English language. The text may be “I want to search for Knox Manage content to help me understand how to apply it to my device security.” The computing system may find the groups of word contexts [‘Knox Manage content’, ‘device security’]. As can be seen, the computing system may identify a deeper meaningful context that is “content” of “Knox Manage” and context of “device security” and not just unigram device or security nouns but the actual bigram by extracting the context from a sentence using logic and parts of speech tagging. The context extraction may not rely on any understanding of what Knox is or any other domain knowledge. Although disclosure describes extracting particular context by particular systems in particular manners, this disclosure contemplates extracting any suitable context by any suitable system in any suitable manner.

In particular embodiments, the computing system may determine, by a language model, a plurality of speech tags for a plurality of words associated with a body of text. The computing system may then process, by a domain-agnostic context extraction (DCE) model, the plurality of words by determining whether each word is a noun, proper noun, or adposition to generate a set of n-grams corresponding to a domain-agnostic context of the body of text. The computing system may further generate, based on the set of n-grams, a contextual summary of the body of text.

Certain technical challenges exist for extracting domain-agnostic context. One technical challenge may include extracting deeper context or meaning from a body of text. The solution presented by the embodiments disclosed herein to address this challenge may be utilizing a word logic that works with groups of proper nouns, nouns, and adpositions, as proper nouns, nouns, and adpositions may help form deeper and more meaningful context from a body of text. Another technical challenge may include generating a domain-agnostic context extraction list that conforms to natural language usage. The solution presented by the embodiments disclosed herein to address this challenge may be determining if the first word in the domain-agnostic context extraction list includes all uppercase letters and its length is greater than 1 as beginning a sentence with one letter may be avoided and entities may not begin with an acronym or an abbreviation.

Certain embodiments disclosed herein may provide one or more technical advantages. A technical advantage of the embodiments may include determining domain-agnostic tags and generating text summary from a group of words as the DCE model may discover ordered groups of words, which may be further used by a domain expert or a model trained in the domain to join the discovered ordered groups of words into a sentence. Another technical advantage of the embodiments may include reliability as the DCE model is not based on closed-source machine-learning models that could give different results due to closed-source code where groups of words output may change over time because of new or different training methods and techniques. Another technical advantage of the embodiments may include improved intelligent searching of documentation and user assisting chatbots that use large language models as domain-agnostic context may be useful for creating and maintaining a continuous bag-of-words to be used in the training of machine-learning models on domain specific knowledge such as services, products, keywords or tags for intelligent searching of documentation, and in the training and finetuning of domain knowledge for the large language models utilized by user assisting chatbots. Another technical advantage of the embodiments may include increased search rank algorithm accuracy, relevance and coherency, as well as improved training for machine-learning models and understanding as the DCE model combined with user intent discovery or understanding may provide granularity for context that user intent alone misses. Certain embodiments disclosed herein may provide none, some, or all of the above technical advantages. One or more other technical advantages may be readily apparent to one skilled in the art in view of the figures, descriptions, and claims of the present disclosure.

Generating a deeper meaningful context from a large body of text to create a meaningful summary or to be able to search a domain using keywords is important in natural language processing. Take the following body of text as an example: Certificates installed in CCM can be used by Email, Browser, VPN, WiFi, or any other 3rd party app. Our company has certificate enrollment protocols, SCEP, EST, CMP clients which can be used for certificate enrollment. The goal may be to determine meaningful contexts such as “certificate enrollment protocols” and “3rd party app.” Conventional systems and methods may extract the context from any short or long body of text but the extracted context may be not specific or may be short (e.g., one word) context that is missing the deeper context or meaning that could be extracted from the text. Continuing with the previous example, conventional systems and methods may only determine “3rd” but miss “certificate enrollment.”

Moreover, to be able to add context awareness, a never-ending process may ensue where bodies of text may be gathered from various sources to gain awareness. The process may be difficult to maintain the current domain context awareness and trends due to the frequency and intensity of efforts required.

To address the limit of conventional systems and methods, the embodiments disclosed herein utilize a word logic that works with groups of proper nouns, nouns, and adpositions to form deeper and more meaningful context from a body of text. In addition, the texts may be from multiple domains. In other words, processing the plurality of words to generate the set of n-grams may be not based on a domain associated with the body of text. The embodiments disclosed herein may be independent of domain types and may qualify as domain-agnostic. To gain deeper meaning of the text, the embodiments disclosed herein may further extend the word logic around the initials (i.e., the first letter of a word found in a group of words that can be used to identify abbreviations or acronyms in a group of words) of the extracted context to identify acronyms and abbreviations.

In particular embodiments, the DCE model may be configured to generate sets of n-grams corresponding to domain-agnostic contexts for bodies of text in a plurality of languages. The computing system may first identify words in the body of text comprising characters. These words may be made up of Unicode or ASCII characters and may be identified as words by separating the groups of characters by whitespace. As an example and not by way of limitation, the whitespace may be based on Unicode U+0020 or a punctuation such as a period or a comma.

In particular embodiments, processing the plurality of words by the DCE model may comprise the following operations. The computing system may iteratively process each word of the plurality of words in sequence by determining whether a current word is a proper noun or a noun based on its corresponding speech tag. Based on the determining, if the current word is not a proper noun or a noun, the computing system may discard the current word. If the current word is a proper noun or a noun, the computing system may store the current word in the set of n-grams. After storing the current word in the set of n-grams, the computing system may iteratively process each of one or more subsequent words following the current word in sequency by determining whether a subsequent word is a proper noun, a noun, or an adposition based on its corresponding speech tag. Based on the determining, if the subsequent word is a proper noun, a noun, or an adposition, the computing system may store the subsequent word in the set of n-grams. If the subsequent word is not a proper noun, a noun, or an adposition, the computing system may save the set of n-grams. Utilizing a word logic that works with groups of proper nouns, nouns, and adpositions may be an effective solution for addressing the technical challenge of extracting deeper context or meaning from a body of text as proper nouns, nouns, and adpositions may help form deeper and more meaningful context from the body of text.

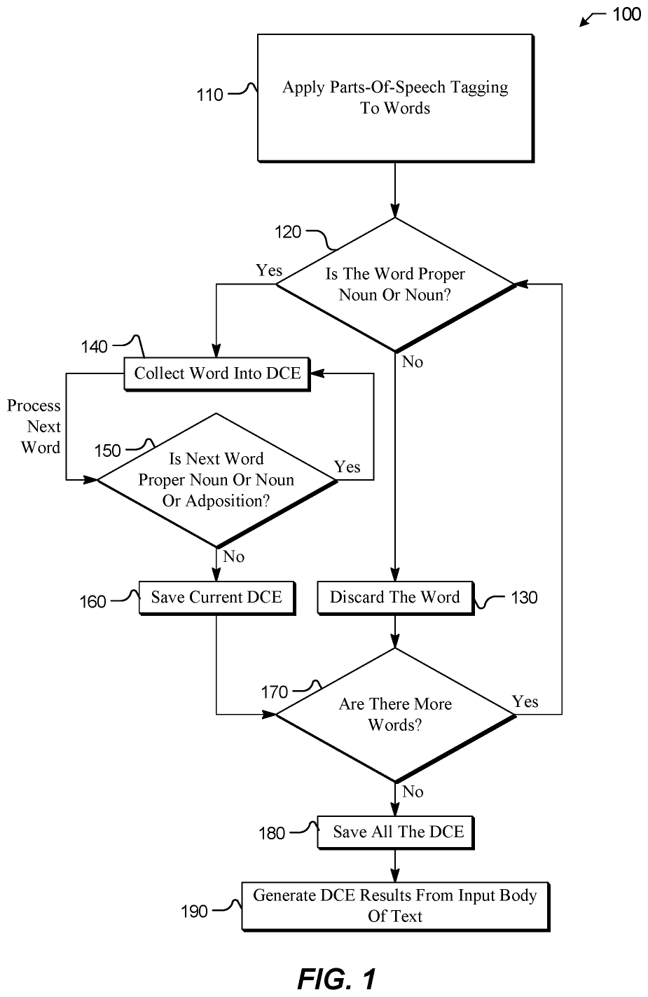

FIG. 1 illustrates an example flow diagram 100 for extracting domain-agnostic context. At step 110, the computing system may apply parts-of-speech tagging to words. As an example and not by way of limitation, an example input may be “I want to search for Knox Manage content to help me understand how to apply it to my device security.” In particular embodiments, the computing system may determine types for the identified words using speech labeling technologies. The computing system may generate a document where each word has been given a grammatical designation. As an example and not by way of limitation, the grammatical designation may be proper noun, noun, or adposition. In particular embodiments, the types may be any way to describe a group of words and may be any type of group or characters.

In particular embodiments, the computing system may search from the beginning of the body of text for a word identified as a noun or a proper noun. At step 120, the computing system may determine whether the word is proper noun or noun.

If the word is not proper noun nor noun, the computing system may discard the word at step 130. If the word is proper noun or noun, the computing system may collect the word into the domain-agnostic context extraction (DCE) list at step 140.

In particular embodiments, the computing system may start the domain-agnostic context extraction list by setting a Boolean flag that can be 1 or 0 (or true or false) and set it to true with a name as “noun_flag” or “propernoun_flag” in memory.

In particular embodiments, the computing system may check if the first word in the domain-agnostic context extraction list comprises all uppercase letters and its length is greater than 1 to avoid beginning a sentence with one letter. If the first word comprises all uppercase letters and its length is not greater than 1, the computing system may add that word to a discovered abbreviation-and-acronym list and set the “propernoun_flag” or “noun_flag” back to false. The computing system may also stop the domain-agnostic context extraction list since entities may not begin with an acronym or an abbreviation because those may be added to the abbreviation-and-acronym list instead. In particular embodiments, the computing system may determine a first word in the set of n-grams comprises all uppercase letters or a length of the first word is not greater than one. The computing system may then add the first word to an abbreviation-and-acronym list. The computing system may further delete the first word from the set of n-grams. Determining if the first word in the domain-agnostic context extraction list includes all uppercase letters and its length is greater than 1 may be an effective solution for addressing the technical challenge of generating a domain-agnostic context extraction list that conforms to natural language usage as beginning a sentence with one letter may be avoided and entities may not begin with an acronym or an abbreviation.

If the first word is an acronym or an abbreviation, the computing system may further start a new domain-agnostic context extraction list for the next word. However, if the word is not an acronym or an abbreviation, the computing system may continue the domain-agnostic context extraction list and collect the first letter from the first word of the domain-agnostic context extraction list to start the collection and detection of an acronym or an abbreviation.

The computing system may then process the next word. In particular embodiments, the computing system may get the next group of characters and add them to a place in memory labeled as “next_token.”

At step 150, the computing system may determine whether the next word is proper noun, noun, or adposition. If the next word is proper noun, noun, or adposition, the flow diagram 100 may return to step 140, where the computing system may collect the next word into the domain-agnostic context extraction list and add the first letter of the added word.

In particular embodiments, the computing system may go through the domain-agnostic context extraction list. The computing system may check if the next proper noun or noun of the list matches the first letters collected in the list with and without the first letter of the “adposition” word in the list to see if the series of letters match. In particular embodiments, capitalization of acronym or abbreviation in the body of text may make no difference in the discovery of the domain-agnostic context extraction list.

In particular embodiments, the computing system may continue until finding a word or punctuation that is not a proper noun, noun, or adposition. The computing system may set a flag of the domain-agnostic context extraction list to false and add the domain-agnostic context extraction list to the list of domain-agnostic context extraction found.

If “propernoun_flag” or “noun_flag” is false and the word is not a proper noun, noun, or adposition, the computing system may ignore things such as punctuation or parenthesis.

If the next word is not proper noun, noun, or adposition, the computing system may save the current domain-agnostic context extraction (DCE) list at step 160.

At step 170, the computing system may determine whether there are more words. If there are more words, the flow diagram 100 may return to step 120. If there are not more words, the computing system may save all the extracted domain-agnostic context (DCE) at step 180.

At step 190, the computing system may generate domain-agnostic context extraction results from the input body of text. As an example and not by way of limitation, the domain-agnostic context extraction results of the example input may be “Knox Manage content” and “device security.”

The embodiments disclosed herein may have a technical advantage of reliability as the DCE model is not based on closed-source machine-learning models that could give different results due to closed-source code where groups of words output may change over time because of new or different training methods and techniques.

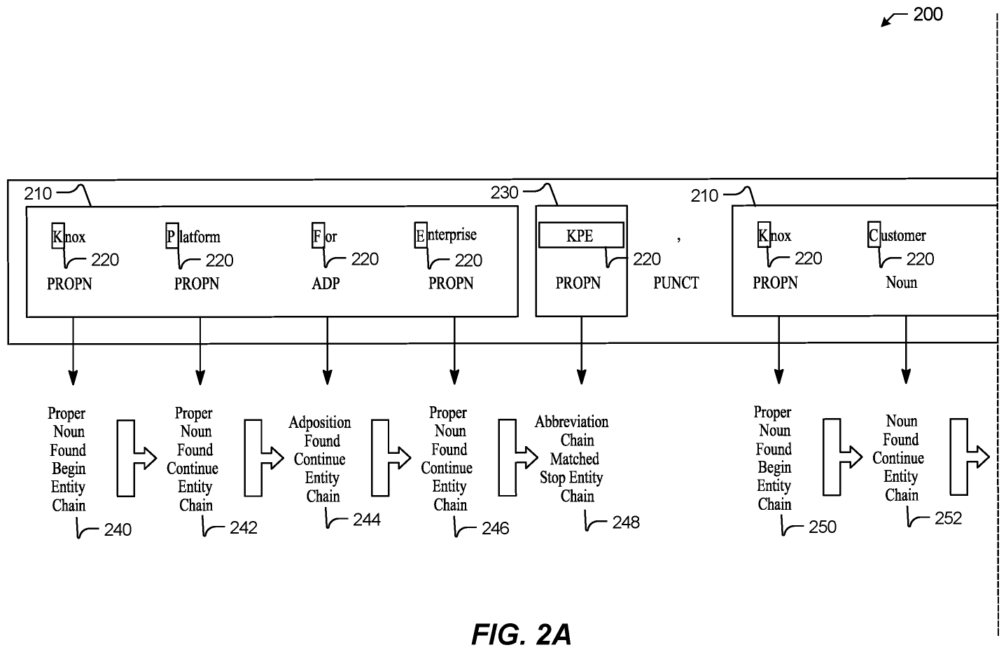

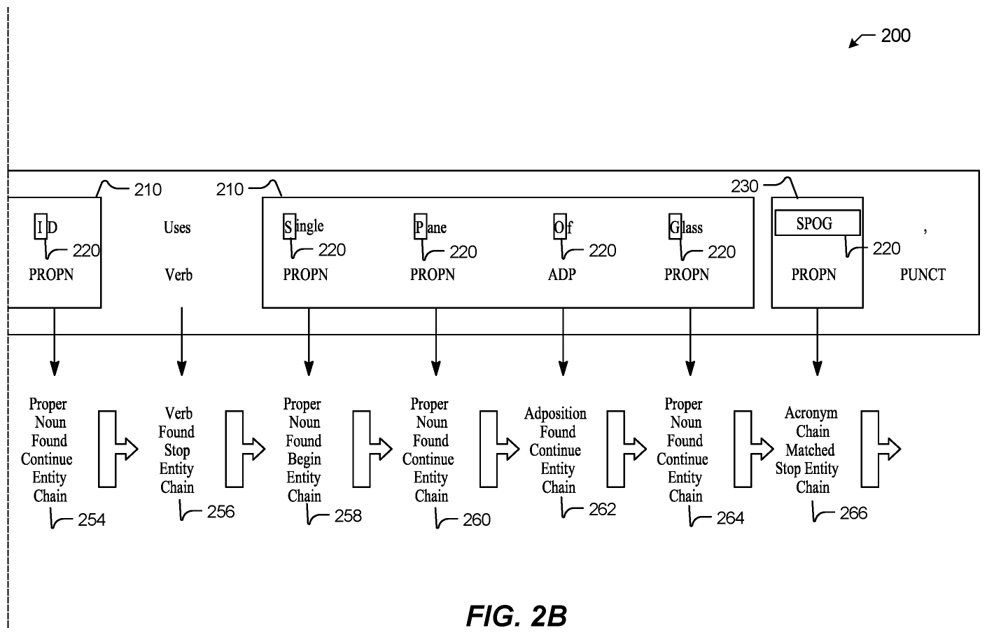

FIGS. 2A-2B illustrate an example diagram 200 for deriving entities from a body of text using domain-agnostic context extraction. In particular embodiments, the computing system may process group of words in any way that describes each word in the group. The computing system may then identify the first proper noun or noun. Once the first proper noun or noun is identified, the computing system may begin the domain-agnostic context extraction list. As illustrated in FIG. 2A, the proper noun, noun, and adposition may be included in box 210.

In particular embodiments, while inside the first domain-agnostic context extraction list, the computing system may create a second domain-agnostic context extraction list from the first letter represented by box 220. The computing system may further create an abbreviation-and-acronym list out of the domain-agnostic context extraction. The identified acronym or abbreviation may be included in box 230.

The example diagram 200 may be as follows. At step 240, the computing system may determine that a proper noun (e.g., “Knox”) is found and to begin entity chain. At step 242, the computing system may determine that a proper noun (e.g., “Platform”) is found and to continue entity chain. At step 244, the computing system may determine that an adposition (e.g., “For”) is found and to continue entity chain. At step 246, the computing system may determine that a proper noun (e.g., “Enterprise”) is found and to continue entity chain. At step 248, the computing system may determine that an abbreviation (e.g., “KPE”) chain matched and to stop entity chain. At step 250, the computing system may determine that a proper noun (e.g., “Knox”) is found and to begin entity chain. At step 252, the computing system may determine that a noun (e.g., “Customer”) is found and to continue entity chain. At step 254, the computing system may determine that a proper noun (e.g., “ID”) is found and to continue entity chain. At step 256, the computing system may determine that a verb (e.g., “Uses”) is found and to stop entity chain. At step 258, the computing system may determine that a proper noun (e.g., “Single”) is found and to begin entity chain. At step 260, the computing system may determine that a proper noun (e.g., “Pane”) is found and to continue entity chain. At step 262, the computing system may determine that an adposition (e.g., “Of”) is found and to continue entity chain. At step 264, the computing system may determine that a proper noun (e.g., “Glass”) is found and to continue entity chain. At step 266, the computing system may determine that an acronym (e.g., “SPOG”) chain matched and to stop entity chain.

In particular embodiments, the computing system may complete the domain-agnostic context extraction list when the next word is identified as acronym or abbreviation, or is not proper noun or noun. Otherwise, the computing system may cancel the domain-agnostic context extraction list if an adposition word is next to another adposition word in the same domain-agnostic context extraction list. FIGS. 2A-2B also show with the boxes 220 how easily initials may be extracted to complement the domain-agnostic context extraction list to identify the best possible abbreviation or acronym based on the extracted domain-agnostic context.

The embodiments disclosed herein further conducted tests on various input text to evaluate the performance. One example input text paragraph is as follows: Knox Manage is a mobile device management (MDM) solution that provides a cloud-based command center with almost 300 enterprise policies to empower IT admins to remotely track, manage, configure, and send messages to devices. This solution can manage any Android, IOS, or Windows 10 or Windows 11 device, but for maximum security, we recommend Samsung Galaxy devices integrated with the Knox platform.

With domain-agnostic context extraction, the computing system may discover proper noun groups of words for tags as: [‘Samsung Galaxy devices’, ‘Android’, ‘Windows’, ‘Knox platform’, ‘iOS’, ‘Knox Manage’]. The computing system may also discover noun groups of words for tags as: [‘enterprise policies’, ‘cloud-based command center’, ‘messages to devices’, ‘device management’]. The computing system may additionally discover acronyms and abbreviations for tags as: [‘IT’, ‘MDM’]. The computing system may further discover ordered groups of words for text summary creation as: [‘Knox Manage’, ‘device management’, ‘MDM’, ‘solution’, ‘cloud-based command center’, ‘enterprise policies’, ‘IT’, ‘admins’, ‘messages to devices’, ‘solution’, ‘Android’, ‘iOS’, ‘Windows’, ‘Windows’, ‘device’, ‘security’, ‘Samsung Galaxy devices’, ‘Knox platform’]. The computing system may therefore create a text summary from the extracted ordered groups of words as: Knox Manage device management MDM solution with cloud-based command center and enterprise policies an IT admins sending messages to devices solution for Android, IOS, Windows device security, and Samsung Galaxy devices with Knox Platform.

The above example shows how domain-agnostic context extraction may be used to generate proper noun, noun groups of words for purposes such as tags or keywords. Acronyms and abbreviations are shown in its own list and are taken from the proper noun and noun groups of words for demonstration purposes. This example also goes further into details about how a large language model may use domain-agnostic context extraction to create a text summary by listing the domain-agnostic context extraction discovered ordered groups of words taken from the proper noun and noun groups of words. Domain-agnostic context extraction also shows the nouns that are not found in a group to add information to the text summary as input to the large language model. Once the large language model has as input the ordered groups of words it may put them together in the same order with word connectors to contextually summarize the original body of text and keep the original meaning of the body of text as best as possible.

Another example input text paragraph is: ‘Network may be monitored’ shown after installing a private CA certificate on device. Environment, Knox Platform for Enterprise (KPE), Samsung devices running Android 4.4 or higher Why do I see “Network may be monitored” after installing a private CA certificate on a device? Google added this network monitoring warning as part of the Android KitKat (4.4) security enhancements. This warning indicates that a device has at least one user-installed certificate, which could be used by malware to monitor encrypted network traffic. Currently, there is no method to prevent this warning message from displaying, and there are no future development plans to change this. To view user certificates installed on your device (Android 8.0), go to: Settings>Lock Screen>Security>Other Security Settings>User. You will see a list of the certificates installed in this menu. If you click the name of a certificate, you can view more details about it and if necessary, remove it.

With domain-agnostic context extraction, the computing system may discovery proper nouns as: [‘Android’, ‘Security’, ‘Samsung devices’, ‘Android KitKat’, ‘Network’, ‘User’, ‘Knox Platform for Enterprise’, ‘Google’, ‘Security Settings’, ‘Screen’]. The computing system may also discover nouns as: [‘network traffic’, ‘certificate on device’, ‘network monitoring warning as part’, ‘warning message’, ‘development plans’, ‘user certificates’, ‘security enhancements’]. The computing system may further discover abbreviations and acronyms as: [‘KPE’, ‘CA’].

Another example input text paragraph is: KPG Knox Platform for Enterprise kpe, Knox customer ID uses Single Pane of Glass spog. With domain-agnostic context extraction, the computing system may discovery proper nouns as: [‘Knox customer ID’, ‘Knox Platform for Enterprise’, ‘Single Pane of Glass’]. The computing system may also discover nouns as: [‘ ’]. The computing system may further discover abbreviations and acronyms as: [‘KPE’, ‘SPOG’, ‘KPG’].

The embodiments disclosed herein also conducted tests on various input text in comparison with conventional methods. One example input text paragraph is: How to receive a Knox customer ID. This article will guide you on how to receive a Knox customer ID. How to receive a Knox customer ID To get your Knox customer ID: 1. Create a Samsung account. 2. Apply for Knox Suite trial. 3. When your customer account is approved, you'll receive a customer ID. Provide your customer ID to your reseller, so they can upload your device details to SamsungKnox.com.

With domain-agnostic context extraction, the computing system may discovery proper nouns as: [‘Samsung account’, ‘Knox Suite trial’, ‘Knox customer ID’]. The computing system may also discover nouns as: [‘device details to SamsungKnox.com’, ‘customer account’, ‘customer ID’]. The computing system may further discover abbreviations and acronyms as: [‘ ’]. By contrast, ChatGPT 4 identified entities as: [‘Knox’, ‘Samsung’, ‘SamsungKnox.com’].

Another example input text paragraph is: KPG Knox Platform for Enterprise KPE, Knox customer ID uses Single Pane of Glass SPOG. With domain-agnostic context extraction, the computing system may discovery proper nouns as: [‘Knox customer ID’, ‘Knox Platform for Enterprise’, ‘Single Pane of Glass’]. The computing system may also discover nouns as: [‘ ’]. The computing system may further discover abbreviations and acronyms as: [‘KPE’, ‘SPOG’, ‘KPG’]. By contrast, ChatGPT 4 was unable to explain or understand that KPG was a separate company entity and grouped KPG with the Knox Platform for Enterprise service as belonging contextually to that entity.

Another example input text paragraph is: Our out-of-box-experience was given to KPG Knox Platform for Enterprise, Knox customer ID uses Single Pane of Glass spog and can be found in kpe. With domain-agnostic context extraction, the computing system may discovery proper nouns as: [‘Single Pane of Glass’, ‘Knox Platform for Enterprise’, ‘Knox customer ID’]. The computing system may also discover nouns as: [‘out-of-the-box-experience’]. The computing system may further discover abbreviations and acronyms as: [‘KPE’, ‘SPOG’, ‘KPG’]. By contrast, spaCY name entity recognizer identified the following entities: [‘Knox’, ‘KPG Knox Platform for Enterprise’, ‘Single Pane’, ‘Glass’, ‘kpe’].

Another example input text paragraph is: Can I create an RSA Key Pair during my out-of-the-box-experience also known as OOBE with Knox Platform for Enterprise device? Summary Can I create an RSA Key Pair on a Knox Platform for Enterprise device? Resolution Yes. A Certificate Signing Request (CSR) provided by Client Certificate Manager (CCM) can be used to generate a RSA Key Pair of size 1024 or 2048 bits. Key Pairs generated by CCM are secured in TrustZone. The Private Key is never revealed and only handled while performing crypto operations. When CCM detects that device is compromised, it is locked and none of the keys can be used on a compromised device. PKCS10 format CSRs generated in CCM can be used with Microsoft CA to issue certificate which can be installed in CCM. Certificates installed in CCM can be used by Email, Browser, VPN, WiFi, or any other 3rd party app. Samsung has certificate enrollment protocols, SCEP, EST, CMP clients which can be used for certificate enrollment. These clients are integrated with CCM and can be used to enroll certificates either in CCM (TrustZone solution) or the default Android credential store.

With domain-agnostic context extraction, the computing system may discovery proper nouns as: [‘Certificate Signing Request’, ‘Knox Platform for Enterprise device’, ‘Client Certificate Manager’, ‘Browser’, ‘Email’, ‘Key’, ‘Key Pairs’, ‘Key Pair’, ‘Microsoft CA’, ‘TrustZone’, ‘Samsung’, ‘TrustZone solution’, ‘WiFi’, ‘Key Pair of size’]. The computing system may also discover nouns as: [‘out-of-the-box-experience’, ‘certificate enrollment protocols’, ‘3rd party app’, ‘default Android credential store’, ‘certificate enrollment’, ‘format CSRs’]. The computing system may further discover abbreviations and acronyms as: [‘SCEP’, ‘PKCS10’, ‘CSR’, ‘VPN’, ‘CMP’, ‘CCM’, ‘OOBE’, ‘EST’, ‘RSA’].

By comparison, a conventional method, i.e., spaCy named entity recognizer may identify the following entities: [‘RSA Key Pair’, ‘Knox Platform for Enterprise’, ‘RSA Key Pair’, ‘Resolution Yes’, ‘CSR’, ‘Client Certificate’, ‘CCM’, ‘RSA’, ‘1024’, ‘2048’, ‘Key Pairs’, ‘CCM’, ‘TrustZone’, ‘The Private Key’, ‘Microsoft’, ‘Browser’, ‘WiFi’, ‘3rd’, ‘Samsung’, ‘SCEP’, ‘CMP’, ‘Android’].

The above example shows more meaningful context is extracted using domain-agnostic context extraction compared to spaCy named entity recognizer. Some of the extracted context has more meaning compared to spaCy named entity recognizer. For example, domain-agnostic context extraction identified ‘3rd party app’ where spaCy named entity recognizer identified ‘3rd’. As another example, domain-agnostic context extraction identified ‘certificate enrollment protocols’ but spaCy named entity recognizer did not identify any match.

The above examples illustrate that by using a combination of agnostic-domain context extraction on contiguous groups of words, the embodiments disclosed herein may identify domain specific groups of words, abbreviations and acronyms to provide more context and gain insight into the text created from any input source. The following are examples that demonstrate the strength of domain knowledge gained from domain-agnostic context extracton: ‘CA certificate on device’, ‘Single Pane of Glass’, ‘Knox customer ID’, ‘CA certificate on device’, ‘Knox Platform for Enterprise’, ‘Android KitKat’, ‘Knox customer ID’, ‘Samsung account’, and ‘Knox Suite trial’.

As validated by the examples, the embodiments disclosed herein have a technical advantage of determining domain-agnostic tags and generating text summary from a group of words as the DCE model may discover ordered groups of words, which may be further used by a domain expert or a model trained in the domain to join the discovered ordered groups of words into a sentence.

In particular embodiments, the DCE model may be not trained on domain-specific data. The DCE model may extract new group of words from a group of words. The new groups of words may provide new knowledge of insights and trends on the groups of words. The new groups of words may be saved to create a continuous bag of words collection that can be used to extend other machine-learning models with finetuning or to train a large language model on how to perform domain-agnostic context extraction with prompt engineering to improve understanding of groups of words beyond the initial understanding or comprehension that the models gained from its initial training. As a result, the embodiments disclosed herein may have a technical advantage of improved intelligent searching of documentation and user assisting chatbots that use large language models as domain-agnostic context may be useful for creating and maintaining a continuous bag-of-words to be used in the training of machine-learning models on domain specific knowledge such as services, products, keywords or tags for intelligent searching of documentation, and in the training and finetuning of domain knowledge for the large language models utilized by user assisting chatbots.

In particular embodiments, the body of text may be associated with a user. The computing system may determine one or more user intents associated with the body of text. As an example and not by way of limitation, one or more user intents comprise one or more of an informational intent indicating the user wants to learn information, a transactional intent indicating the user seeks for a particular product or service, or a navigational intent indicating the user seeks for a particular site. The computing system may further generate an understanding of the body of text based on the set of n-grams and the one or more user intents. The computing system may further update one or more machine-learning models based on the one or more user intents and the set of n-grams. As an example and not by way of limitation, the one or more machine-learning models may comprise one or more of the language model, the DCE model, or a ranking model. For example, the extracted domain-agnostic context may be used to improve search ranking algorithms and training machine-learning algorithms together with discovered user intents from the body of text. By combining the extracted context from the DCE model with discovered user intent, the computing system may complete the understanding of what a body of text infers. Therefore, the computing system may improve ranking by giving weight and relevancy to correct tags or keyword frequency of text being searched by ranking algorithms. The computing system may also provide the complete understanding of a body of text to a machine-learning model to improve training, understanding and coherency. As a result, the embodiments disclosed herein may have a technical advantage of increased search rank algorithm accuracy, relevance and coherency, as well as improved training for machine-learning models and understanding as the DCE model combined with user intent discovery or understanding may provide granularity for context that user intent alone misses.

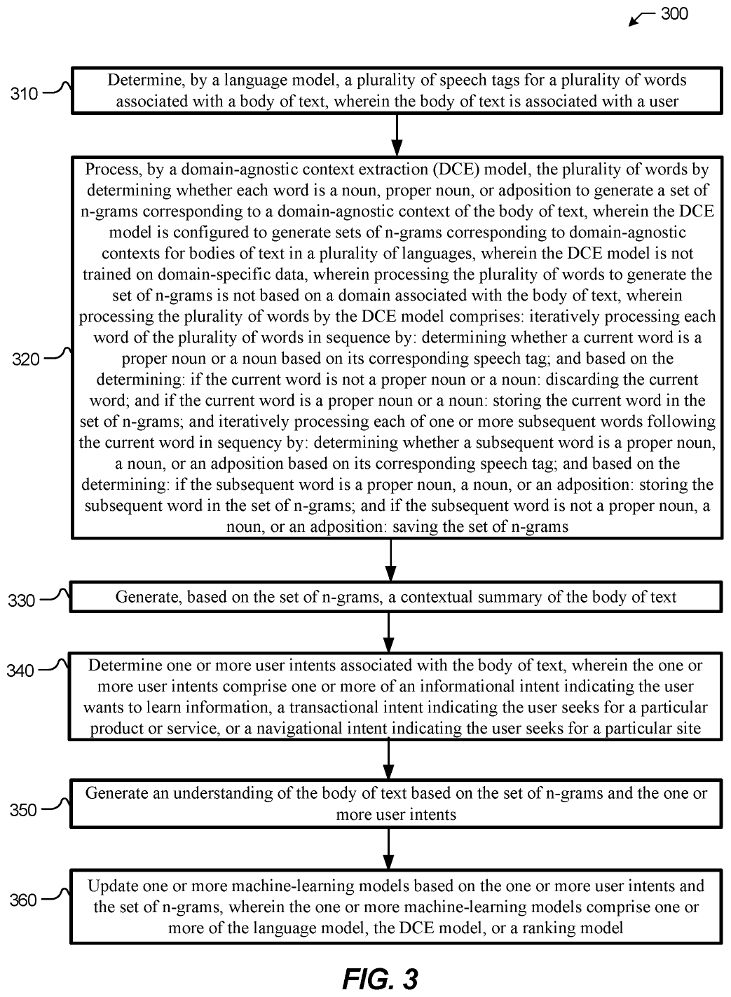

FIG. 3 illustrates is a flow diagram of a method 300 for extracting domain-agnostic context, in accordance with the presently disclosed embodiments. The method 300 may be performed utilizing one or more processing devices (e.g., a computing system) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing wireless communication data, software (e.g., instructions running/executing on one or more processors), firmware (e.g., microcode), or some combination thereof.

The method 300 may begin at step 310 with the one or more processing devices (e.g., the computing system). For example, in particular embodiments, the computing system may determine, by a language model, a plurality of speech tags for a plurality of words associated with a body of text, wherein the body of text is associated with a user. The method 300 may then continue at step 320 with the one or more processing devices (e.g., the computing system). For example, in particular embodiments, the computing system may process, by a domain-agnostic context extraction (DCE) model, the plurality of words by determining whether each word is a noun, proper noun, or adposition to generate a set of n-grams corresponding to a domain-agnostic context of the body of text, wherein the DCE model is configured to generate sets of n-grams corresponding to domain-agnostic contexts for bodies of text in a plurality of languages, wherein the DCE model is not trained on domain-specific data, wherein processing the plurality of words to generate the set of n-grams is not based on a domain associated with the body of text, wherein processing the plurality of words by the DCE model comprises: iteratively processing each word of the plurality of words in sequence by: determining whether a current word is a proper noun or a noun based on its corresponding speech tag; and based on the determining: if the current word is not a proper noun or a noun: discarding the current word; and if the current word is a proper noun or a noun: storing the current word in the set of n-grams; and iteratively processing each of one or more subsequent words following the current word in sequency by: determining whether a subsequent word is a proper noun, a noun, or an adposition based on its corresponding speech tag; and based on the determining: if the subsequent word is a proper noun, a noun, or an adposition: storing the subsequent word in the set of n-grams; and if the subsequent word is not a proper noun, a noun, or an adposition: saving the set of n-grams. The method 300 may then continue at step 330 with the one or more processing devices (e.g., the computing system). For example, in particular embodiments, the computing system may generate, based on the set of n-grams, a contextual summary of the body of text. The method 300 may then continue at step 340 with the one or more processing devices (e.g., the computing system). For example, in particular embodiments, the computing system may determine one or more user intents associated with the body of text, wherein the one or more user intents comprise one or more of an informational intent indicating the user wants to learn information, a transactional intent indicating the user seeks for a particular product or service, or a navigational intent indicating the user seeks for a particular site. The method 300 may then continue at step 350 with the one or more processing devices (e.g., the computing system). For example, in particular embodiments, the computing system may generate an understanding of the body of text based on the set of n-grams and the one or more user intents. The method 300 may then continue at step 360 with the one or more processing devices (e.g., the computing system). For example, in particular embodiments, the computing system may update one or more machine-learning models based on the one or more user intents and the set of n-grams, wherein the one or more machine-learning models comprise one or more of the language model, the DCE model, or a ranking model. Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for extracting domain-agnostic context including the particular steps of the method of FIG. 3, this disclosure contemplates any suitable method for extracting domain-agnostic context including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

### Systems and Methods

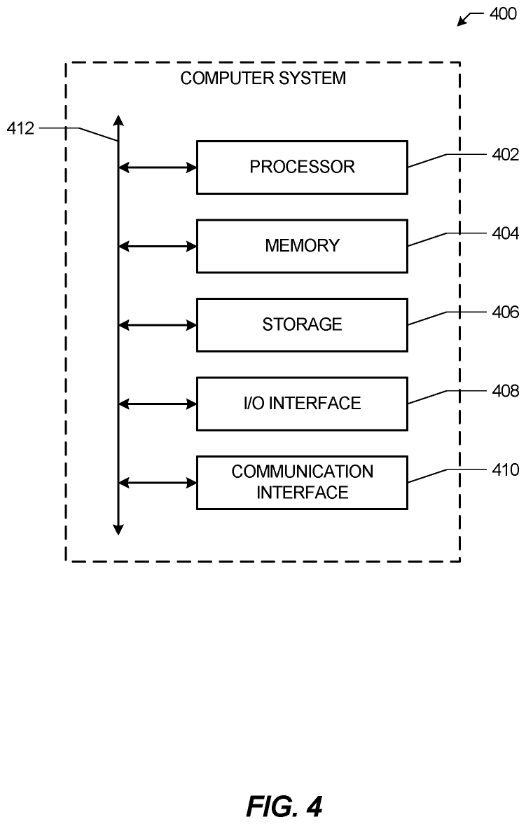

FIG. 4 illustrates an example computer system 400 that may be utilized to extract domain-agnostic context, in accordance with the presently disclosed embodiments. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks.

Where appropriate, one or more computer systems 400 may perform without substantial spatial or temporal limitation one or more steps of one or more methods described or illustrated herein. As an example, and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement. In particular embodiments, processor 402 includes hardware for executing instructions, such as those making up a computer program. As an example, and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example, and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402.

Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example, and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere).

One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memory devices, where appropriate. Although this disclosure describes and illustrates particular memory, this disclosure contemplates any suitable memory.

In particular embodiments, storage 406 includes mass storage for data or instructions. As an example, and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example, and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it.

As an example, and not by way of limitation, computer system 400 may communicate with an ad hoc network, a personal area network (PAN), a local area network (LAN), a wide area network (WAN), a metropolitan area network (MAN), an ultra-wideband network (UWB), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example, and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

### MISCELLANEOUS

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, “automatically” and its derivatives means “without human intervention,” unless expressly indicated otherwise or indicated otherwise by context.

The embodiments disclosed herein are only examples, and the scope of this disclosure is not limited to them. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
determining, by a language model, a plurality of speech tags for a plurality of words associated with a body of text;
processing, by a domain-agnostic context extraction (DCE) model, the plurality of words by determining whether each word is a noun, proper noun, or adposition to generate a set of n-grams corresponding to a domain-agnostic context of the body of text; and
generating, based on the set of n-grams, a contextual summary of the body of text.

2. The method of claim 1, wherein processing the plurality of words by the DCE model comprises:
iteratively processing each word of the plurality of words in sequence by:
determining whether a current word is a proper noun or a noun based on its corresponding speech tag; and
based on the determining:
if the current word is not a proper noun or a noun:
discarding the current word; and
if the current word is a proper noun or a noun:
storing the current word in the set of n-grams; and
iteratively processing each of one or more subsequent words following the current word in sequency by:
determining whether a subsequent word is a proper noun, a noun, or an adposition based on its corresponding speech tag; and
based on the determining:
if the subsequent word is a proper noun, a noun, or an adposition:
storing the subsequent word in the set of n-grams; and
if the subsequent word is not a proper noun, a noun, or an adposition:
saving the set of n-grams.

3. The method of claim 1, wherein processing the plurality of words to generate the set of n-grams is not based on a domain associated with the body of text.

4. The method of claim 1, wherein the DCE model is not trained on domain-specific data.

5. The method of claim 1, further comprising:
determining a first word in the set of n-grams comprises all uppercase letters or a length of the first word is not greater than one;
adding the first word to an abbreviation-and-acronym list; and
deleting the first word from the set of n-grams.

6. The method of claim 1, wherein the body of text is associated with a user, and wherein the method further comprises:
determining one or more user intents associated with the body of text; and
generating an understanding of the body of text based on the set of n-grams and the one or more user intents.

7. The method of claim 6, wherein the one or more user intents comprise one or more of:
an informational intent indicating the user wants to learn information;
a transactional intent indicating the user seeks for a particular product or service; or
a navigational intent indicating the user seeks for a particular site.

8. The method of claim 6, further comprising:
updating one or more machine-learning models based on the one or more user intents and the set of n-grams, wherein the one or more machine-learning models comprise one or more of the language model, the DCE model, or a ranking model.

9. The method of claim 1, wherein the DCE model is configured to generate sets of n-grams corresponding to domain-agnostic contexts for bodies of text in a plurality of languages.

10. An electronic device comprising:
one or more non-transitory computer-readable storage media including instructions; and
one or more processors coupled to the storage media, the one or more processors configured to execute the instructions to:
determine, by a language model, a plurality of speech tags for a plurality of words associated with a body of text;
process, by a domain-agnostic context extraction (DCE) model, the plurality of words by determining whether each word is a noun, proper noun, or adposition to generate a set of n-grams corresponding to a domain-agnostic context of the body of text; and
generate, based on the set of n-grams, a contextual summary of the body of text.

11. The electronic device of claim 10, wherein processing the plurality of words by the DCE model comprises:
iteratively processing each word of the plurality of words in sequence by:
determining whether a current word is a proper noun or a noun based on its corresponding speech tag; and
based on the determining:
if the current word is not a proper noun or a noun:
discarding the current word; and
if the current word is a proper noun or a noun:
storing the current word in the set of n-grams; and
iteratively processing each of one or more subsequent words following the current word in sequency by:
determining whether a subsequent word is a proper noun, a noun, or an adposition based on its corresponding speech tag; and
based on the determining:
if the subsequent word is a proper noun, a noun, or an adposition:
storing the subsequent word in the set of n-grams; and
if the subsequent word is not a proper noun, a noun, or an adposition:
saving the set of n-grams.

12. The electronic device of claim 10, wherein processing the plurality of words to generate the set of n-grams is not based on a domain associated with the body of text.

13. The electronic device of claim 10, wherein the DCE model is not trained on domain-specific data.

14. The electronic device of claim 10, wherein the one or more processors are further configured to execute the instructions to:
determine a first word in the set of n-grams comprises all uppercase letters or a length of the first word is not greater than one;
add the first word to an abbreviation-and-acronym list; and
delete the first word from the set of n-grams.

15. The electronic device of claim 10, wherein the body of text is associated with a user, and wherein the one or more processors are further configured to execute the instructions to:
determine one or more user intents associated with the body of text; and
generate an understanding of the body of text based on the set of n-grams and the one or more user intents.

16. The electronic device of claim 10, wherein the DCE model is configured to generate sets of n-grams corresponding to domain-agnostic contexts for bodies of text in a plurality of languages.

17. A computer-readable non-transitory storage media comprising instructions executable by a processor to:
determine, by a language model, a plurality of speech tags for a plurality of words associated with a body of text;
process, by a domain-agnostic context extraction (DCE) model, the plurality of words by determining whether each word is a noun, proper noun, or adposition to generate a set of n-grams corresponding to a domain-agnostic context of the body of text; and
generate, based on the set of n-grams, a contextual summary of the body of text.

18. The computer-readable non-transitory storage media of claim 17, wherein processing the plurality of words by the DCE model comprises:
iteratively processing each word of the plurality of words in sequence by:
determining whether a current word is a proper noun or a noun based on its corresponding speech tag; and
based on the determining:
if the current word is not a proper noun or a noun:
discarding the current word; and
if the current word is a proper noun or a noun:
storing the current word in the set of n-grams; and
iteratively processing each of one or more subsequent words following the current word in sequency by:
determining whether a subsequent word is a proper noun, a noun, or an adposition based on its corresponding speech tag; and
based on the determining:
if the subsequent word is a proper noun, a noun, or an adposition:
storing the subsequent word in the set of n-grams; and
if the subsequent word is not a proper noun, a noun, or an adposition:
saving the set of n-grams.

19. The computer-readable non-transitory storage media of claim 17, wherein processing the plurality of words to generate the set of n-grams is not based on a domain associated with the body of text.

20. The computer-readable non-transitory storage media of claim 17, wherein the DCE model is not trained on domain-specific data.
